(19) United States
(12) Patent Application Publication
(10) Pub. No.: US 2006/0193467 A1
(43) Pub. Date: Aug. 31, 2006

(54) Access control in a computer system

(76) Inventor: Joseph Levin, Arlington, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/355,916

(22) Filed: Feb. 16, 2006

Related U.S. Application Data
(60) Provisional application No. 60/653,417, filed on Feb. 16, 2005.

(51) Int. Cl. H04M 1/00

(52) U.S. Cl. 379/413.04

(57) ABSTRACT

A technique for controlling a software process's access to securable objects that utilizes the native security mechanisms of an operating system. According to an aspect of the technique (i) a group is created, (ii) rights for the group are defined, (iii) the group is associated with a program image and (iv) the group is assigned to processes created from the program image. Specifically, access tokens associated with processes created from the program image are modified to include the groups associated with the program image. The modified access tokens are used by the operating system's native security mechanisms to determine if the processes, created from the program image, may gain access to securable objects.

### RELATED APPLICATION

This application claims the benefit of U.S. Provisional Application No. 60/653,417, entitled “ACCESS CONTROL IN A COMPUTER SYSTEM,” by Joseph Levin, filed on Feb. 16, 2005, the entire teachings of which are incorporated herein by reference.

### BACKGROUND

Enterprise boundaries are expanding, creating a need for faster, easier collaboration among employees, customers and business partners. As enterprises expand, they have become increasingly vulnerable to potential new threats to the integrity of their vital corporate data and applications. In response to these potential threats, operating system vendors have built various mechanisms into their operating systems to control access to data and applications that are accessible via the operating systems.

Operating systems have incorporated various security features that are used to control access to data and applications under control of the operating system. These features, collectively known as the operating system's native security system, may include securable objects, groups, security principals, permissions, access tokens, security descriptors, access control entries, access control lists and access inheritance.

Securable objects are any real or abstract objects to which controlled access may be delegated. Examples of securable objects include files, folders (directories), registry keys and active directory objects (ADOs).

Groups are collections of users, computers and other groups that have access to the operating system. Groups act as a management tool in that they enable, e.g., system administrators, to simultaneously allocate permissions on a single securable object to multiple users and computers. Groups comprise members which may be some combination of users, computers and other groups. Permissions that are granted to a group serve all of the members of the group. Thus, for example, if an administrator's group is granted permission to change power management settings in a computer system, any member of the administrator's group has permission to change the power management settings.

Group membership is transitive. Thus, for example, if a user is a member of group “A” and group “A” is a member of group “B,” the user is a member of group “B” as well. In practice, groups are often associated with job roles.

Typically, groups are granted only the necessary permissions required to perform their job roles. Granting a new user permission to perform a particular job role usually involves defining the necessary permissions for a group and adding the user to the group's membership.

Security principals are entities that may be allocated certain permissions to a securable object. Examples of security principals include users, computers and groups. Security principals are usually identified by security identifiers (SIDs).

A permission is an authorization to perform a particular operation on a specific securable object. In other words, permissions (access rights) specify a type of access that a particular security principal has to a particular securable object. The type of access depends on the type of securable object. For example, access permissions associated with a file may grant a set of security principals permission to both read and modify the file, and other security principals permission to only read the file. Permissions are typically stored in security descriptors (described below) which are associated with the securable objects.

An access token is an object that defines a security context of a process or a thread. An access token is typically represented as a data structure that contains information about a security principal (e.g., user) that is associated with a process or thread which is typically created by the associated principal. The access token may contain a list of identifiers that represents the security principal and any groups to which the security principal belongs, and a list of privileges including those granted to the security principal as well as groups to which the security principal belongs. The list of identifiers is used in conjunction with information contained in a security descriptor associated with a securable object to determine if the process associated with the access token has access to the securable object.

Security descriptors are structures that contain access permissions for a securable object. In a typical arrangement, each securable object has only one security descriptor associated with it. The security descriptor may contain an owner attribute which identifies a security principal to which permission to modify the security descriptor is granted, a list of discretionary access control entries (ACEs) which contain information about allocated permissions for various security principals and a list of system ACEs which contain information about access attempts that are audited. The list of discretionary ACEs is often called a Discretionary Access Control List (DACL). The list of system ACEs is often called a Security Access Control List (SACL). Usually, each security descriptor has at least one DACL and one SACL.

Discretionary ACEs define permissions that security principals have to access a particular securable object. Typically, these ACEs are represented as data structures that are linked-in to the DACL. There are typically two types of discretionary ACEs: an allow ACE and a deny ACE. An allow ACE typically grants a security principal some access to a securable object and a deny ACE typically denies a security principal some access to a securable object. A local discretionary ACE is an ACE that is directly assigned to securable object as opposed to being inherited. An inherited discretionary ACE is an ACE that is inherited by a securable object through a concept known as “access inheritance.”

Access inheritance is a concept that involves having a securable object inherit access from another source, such as a parent securable object. Typically, an operating system represents securable objects as a data structure organized as a tree. Usually, parent securable objects are represented at parent nodes in the tree and child securable objects are represented at child nodes in the tree. Security for a particular child securable object is inherited from the child object's parent securable object. Thus, a discretionary ACE contained in a parent object's security descriptor is typically applicable to the parent's child objects as well.

DACLs are ordered lists of discretionary ACE structures that are typically ordered based on a priority scheme that is used to determine whether a security principal should be granted or denied access to a securable object. Often the priority scheme is as follows: (i) deny ACEs are higher priority than allow ACEs and (ii) local ACEs are a higher priority than inherited ACEs. In the first situation, everything else being equal, if a security descriptor contains ACE entries that both allow access and deny access to a securable object, access to the object is typically denied. In the second situation, if a child's security descriptor has a deny ACE that is inherited from a parent and a local allow ACE in the child's security descriptor, the child is typically allowed access to the securable object even though permission may be denied by the inherited ACE.

Security ACEs define which attempts to access securable objects by security principals are audited. Security ACEs are typically represented as data structures that are linked-in to a SACL. Security ACEs may contain a header that indicates whether auditing is triggered by a successful or failed attempt to access the secure object, a security principal identifier (ID) that identifies the security principal that is audited and an access mask that lists the operations that are audited. A local security ACE is an ACE that is directly assigned to securable object as opposed to being inherited. An inherited security ACE is an ACE that is inherited by a securable object through “access inheritance.”

A privilege is a right that a security principal has to perform various system-related operations on a computer, such as shutting down the system, loading device drivers or changing the system's time. While security descriptors and permissions are usually associated with an entity to which access is being granted or denied, privileges are typically associated with operations that are not directly associated with any single entity.

A program image is an executable image or an executable dynamically linked library (DLL). A process is an instance of one or more program images that, e.g., run under control of an operating system. A thread is a thread of execution within a process. As used hereafter, the word process refers to a process and/or a thread.

In some operating systems, processes are the actual agents of access requests. Though access tokens are associated with users or computers, in practice operations to access securable objects are performed via a process. In a typical arrangement, when a user executes a program image, a process is created and a copy of the user's access token is created and added to the process. When the process attempts to access a securable object, the access token is used with the securable object's security descriptor to determine if the process has access to the object.

For example, assume a user tries to open a spreadsheet file using a process created from a spreadsheet program image. A copy of the user's access token is added to the process. To determine whether to allow the process to read the contents of the spreadsheet, the operating system typically performs an access check that compares information in the added access token with the file's security descriptor. This comparison may involve scanning the discretionary ACEs contained in the file's security descriptor to determine if a security principal listed in the process's access token should be granted access to the file. If so, the process is granted access to the file, otherwise, the process is denied access to the file.

One problem with the above-described arrangement is that a process is typically given access to securable objects based on the access granted to the security principal that created the process. In other words, the process “inherits” the security settings that are associated with the security principal. The process does not have any security settings that are attributed to the process itself.

Existing security access applications that run on top of the operating system may be used to overcome this shortcoming; however, these applications typically do not rely on the operating system's native security system to control access to securable objects. Rather, they often require that the operating system's native security system be “opened” significantly or be completely disabled to allow the security mechanisms implemented in the security application to control access to the securable objects. This leaves open the possibility of a security breach in the event that the security access application fails to limit access to a securable object when it should have limited access.

### SUMMARY

The present invention overcomes shortcomings associated with the prior art by incorporating a technique that controls a process's access to securable objects as well as auditing the process's access to the securable objects using a native security system (NSS) which is part of an operating system. According to an aspect of the present invention (i) a group is created, (ii) rights for the group are defined, (iii) the group is associated with a program image and (iv) the group is assigned to processes created from the program image. Rights associated with the group are used by the operating system's NSS to determine if the processes may access certain securable objects as well as determine if the processes' access to the securable object is audited.

In the illustrated embodiment, a group is created, rights are defined for the group and the group is associated with a program image. Rights for the group are defined for securable objects whose access is controlled by an NSS that is part of an operating system. A user creates a process of the program image by executing it. An access token associated with the user is copied into the process. In addition, the group associated with the program image is copied into a security privilege list contained in the access token. The modified access token is used by the NSS to determine whether the process has access to the securable objects as well as determine if the process's access to particular securable objects is audited.

Advantageously, the present invention enables the NSS of an operating system to be used to determine if a process has access to securable objects as well as determine whether the process's access to the securable objects is audited. Thus, the present invention obviates having to open or disable the operating system's NSS which may be required if other techniques are used to control the process's access to the securable objects.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a high-level partial schematic block diagram of an exemplary computer system that may be used with the present invention.

FIG. 2 is a schematic block diagram of a security descriptor that may be used with the present invention.

FIG. 3 is a schematic block diagram of an access control entry (ACE) that may be used with the present invention.

FIG. 4 is a schematic block diagram of an access token that may be used with the present invention.

FIG. 5 is a schematic block diagram of a database that may be used to identify group membership for a particular program image in accordance with an aspect of the present invention.

FIG. 6 is a flow chart of a sequence of steps that may be used to associate a program image with a group in accordance with an aspect of the present invention.

FIG. 7 is a flow chart of a sequence of steps that may be used to generate an access token for a process and assign the access token to the process in accordance with an aspect of the present invention.

FIG. 8 is a flow chart of a sequence of steps that may be used to generate an access token for a child process and assign the access token to the child process in accordance with an aspect of the present invention.

FIGS. 9A-B are a flow chart of a sequence of steps that may be used to create a process, generate an access token for the process and utilize the process's access token to access a securable object as well as audit access to the securable object in accordance with an aspect of the present invention.

### DETAILED DESCRIPTION

A description of preferred embodiments of the invention follows.

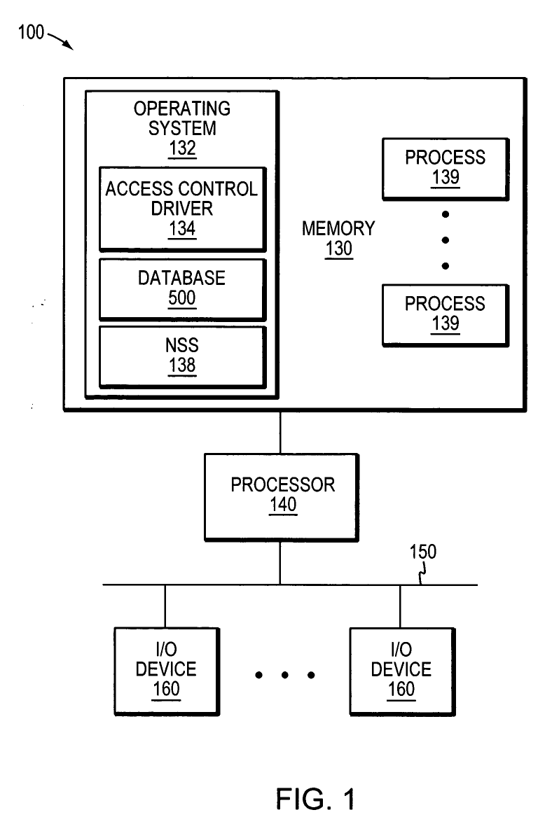

FIG. 1 is a high level partial schematic block diagram of an exemplary computer system 100 that may be used with the present invention. System 100 comprises a memory 130, a processor 140 and one or more input/output (I/O) devices 160. The memory 130 is a computer-readable medium organized as a random-access memory (RAM) that is implemented using various RAM devices, such as dynamic RAM (DRAM) devices. The memory is configured to hold various computer-executable instructions and data structures including computer-executable instructions and data structures that implement aspects of the present invention. It should be noted that other computer-readable mediums, such as disk units and flash memory, may be configured to hold computer-readable instructions and data that implement aspects of the present invention. In addition, it should be noted that various electromagnetic signals may be encoded to carry instructions and data that implement aspects of the present invention over e.g., a data network.

The processor 140 is a conventional processor, such as an Intel Pentium 4 processor available from Intel Corporation, Santa Clara, Calif. The I/O devices 160 may include various conventional I/O devices associated with computer systems, such as disk units, display devices, keyboard input devices, network interfaces and so on.

Memory 130 contains an operating system 132 that holds an access control driver 134, a database 500, a native security system (NSS) 138 and one or more processes 139. The operating system 132 is a conventional operating system, such as the Microsoft Windows 2000 operating system available from Microsoft Corporation, Redmond, Wash., that provides various conventional operating system functions. These functions may include maintaining software processes (e.g., processes 139), providing various software support functions for the software processes and implementing a security system, such as NSS 138. NSS 138 is a conventional native security system that contains functions configured to implement various predefined security policies for operating system 132. These functions are geared towards controlling a process's access to various securable objects (e.g., files, directories, etc.) associated with the operating system 132 as well as auditing the process's access to the various securable objects. Processes 139 are software processes that may include processes created from various program images (not shown) contained on e.g., an I/O device 160 and executed e.g., by users. Illustratively, access control driver 134 is software that integrates closely with the operating system 132. Driver 134 is illustratively configured to, in accordance with an aspect of the present invention, assign a program image's group to a token associated with a process created from the program image. Database 500 is illustratively a predefined data structure that holds information (described further below) that is used by the access control driver 134 to identify group membership for various program images.

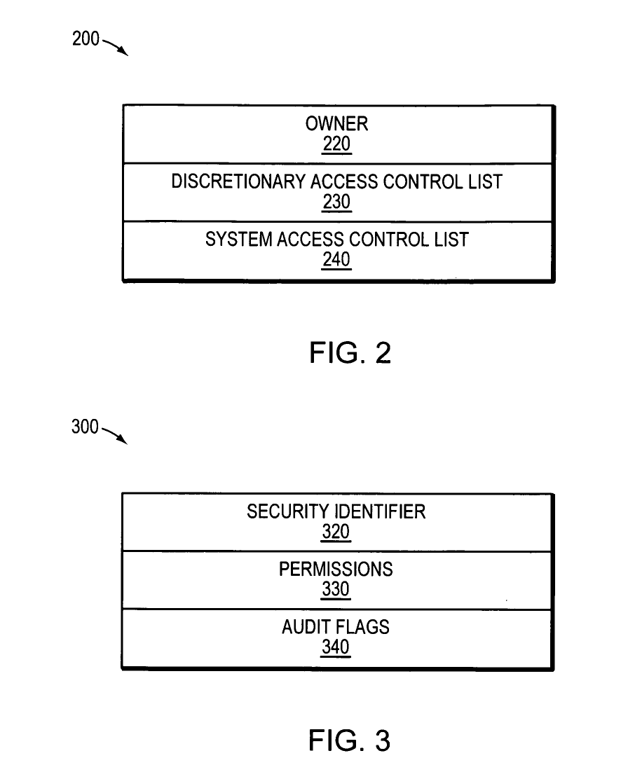

In system 100, access permissions for a securable object are illustratively represented in a security descriptor data structure associated with the securable object. FIG. 2 is a schematic block diagram of a security descriptor data structure 200 that may be used with the present invention. Descriptor 200 comprises an owner field 220, a discretionary access control list (DACL) field 230 and a system access control (SACL) field 240. It should be noted that descriptor 200 may contain other fields, such as a group field which holds identifiers for a primary group associated with the security descriptor.

The owner field 220 holds a value that identifies a securable object's owner. An owner is typically a security principal that is granted access to modify permissions associated with the securable object and grant other security principals rights to take ownership of the securable object. The DACL field 230 holds discretionary access control entries (described further below) that specify, e.g., whether a particular security principal has access to the securable object. The SACL field 240 holds security access control entries (described further below) that specify, e.g., whether a user's attempted access to a securable object is audited. The contents of the DACL field 230 and SACL field 240 are typically controlled by the owner 220 of the securable object. That is, the owner 220 has permission to define the contents of the DACL 230 and SACL 240 fields.

Some ACEs may specify various rights that security principals have with regards to accessing a securable object. In addition, other ACEs may specify whether access to the securable object is audited. FIG. 3 is a schematic block diagram of an ACE 300 that may be used with the present invention. ACE 300 is illustratively a data structure comprising a security identifier (SID) field 320, a permissions field 330 and an audit flags field 340.

The SID field 320 holds a value that illustratively identifies a security principal for which the particular ACE applies. The permissions field 330 holds a value that illustratively indicates permissions granted to the security principal defined in the security identifier field 320. This permission may include a value that indicates the security principal has access to the securable object, is denied access to the securable object or that attempts by the security principal to access the securable object are audited. The audit flags field 340 holds a value that illustratively indicates whether auditing is triggered by the security principal's successful access to the securable object, the security principal's failed access to the securable object or both.

It should be noted that ACE 300 may contain other fields, such as a header field that identifies the ACE data structure, an object type field which specifies a type of object associated with the ACE and an inherited object type field which specifies a type of object that may inherit the ACE. In addition, ACE 300 may contain an access operations mask field that holds a value that illustratively represents a list of access operations (e.g., read, write, execute) that are audited.

An access token is an object that contains information about an identity associated with a security principal. For example, when a user logs into system 100, a logon process authenticates the user's logon credentials. If authentication is successful, the logon process uses the logon credentials to generate an access token that is associated with the user. A user's access token is attached (copied) to every process that executes on the user's behalf. When a process interacts with a securable object or tries to perform a system task that requires privileges, the operating system checks the access token associated with the process or thread to determine whether it has access to the securable object.

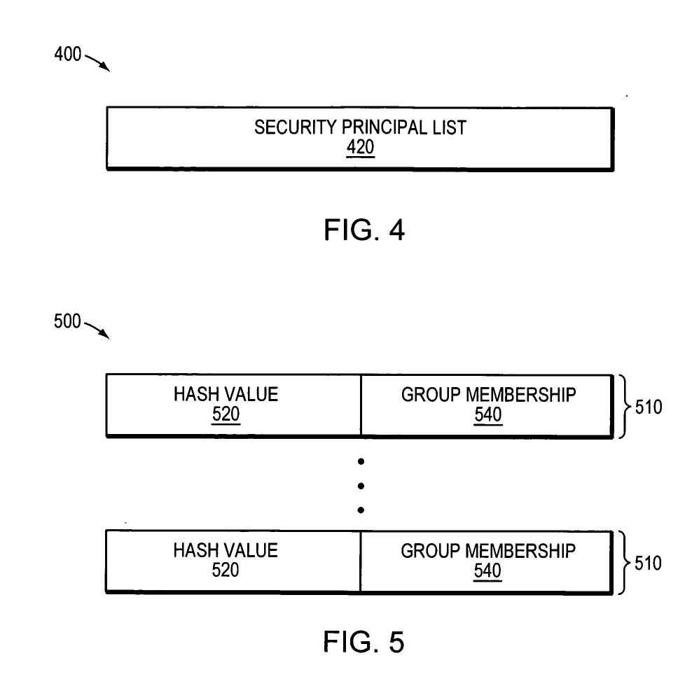

FIG. 4 is a schematic block diagram of an access token 400 that may be used with the present invention. Access token 400 illustratively comprises a security principal list 420. The security principal list field 420 holds a value that represents a list of security principals associated with the token. For example, for a user, the security principal list 420 illustratively holds a SID associated with the user and a list of a SIDs for groups that include the user. It should be noted that access token 400 may contain other fields, such as e.g., a source which indicates the process that caused the access token to be created, a type which indicates whether the access token is a primary or impersonation token, an impersonation level which indicates to what extent a service can adopt the security context of a client represented by this access token, a privilege list and statistics which gives various information about the access token.

As noted above, database 500 (FIG. 1) is a data structure that illustratively holds information (described further below) that is used by the access control driver 134 to identify group membership for various program images. This information illustratively relates program images with one or more groups. FIG. 5 is a schematic block diagram of a database 500 that may be advantageously used with the present invention.

Database 500 is illustratively organized as a table comprising one or more entries 510 wherein each entry is configured to hold information that relates group membership to one or more program images. Specifically, entry 510 comprises a hash value field 520 and a group membership field 540. The hash value field 520 illustratively holds a hash value associated with one or more program images. The group membership field 540 holds a value that illustratively represents one or more groups associated with the program images.

It should be noted that the hash field 520 may illustratively hold multiple hash values for multiple related program images. For example, a particular application program may have multiple program images associated with it. These images may include multiple versions of the application program. Here, the hash value field 520 may hold a list of hash values that represent the multiple versions of the application program.

As noted above, database 500 is used to establish a relationship between group membership and program images. It should be noted that database 500 is just one way this relationship may be established. Other techniques may be used to establish this relationship. What is important, here, is that the driver 134 is aware of the relationship between group membership and program images.

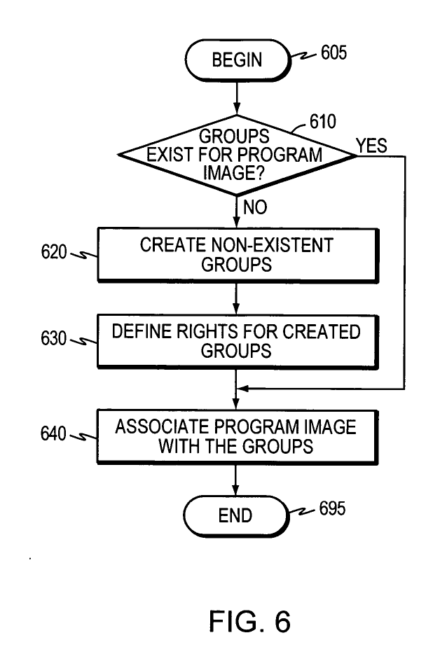

Illustratively, database 500 is a preconfigured database that is populated by, e.g., a system administrator. FIG. 6 is a flow chart of a sequence of steps that may be used to configure database 500 in accordance with an aspect of the present invention. The sequence begins at step 605 and proceeds to step 610 where a check is performed to determine if groups that are to be associated with a program image exist. If so, the sequence proceeds to step 640. Otherwise, the sequence proceeds to step 620 where the non-existent groups are created. Next at step 630, rights are defined for the created groups. Illustratively, discretionary ACEs for securable objects that are accessed by the group are defined and placed in the securable objects' DACLs 230. These discretionary ACEs define rights that the groups have with respect to accessing the securable objects. In addition, system ACEs are defined and placed in the securable object's SACL 240 in a conventional manner. The system ACEs define the types of access attempts to the securable object made by the groups that are audited.

Next at step 640, the program image is associated with the groups. Illustratively, a hash value for the program image is generated in a conventional manner. The hash value is then used to determine if an entry 510 exists in database 500 whose hash value field 520 illustratively contains a value that matches the generated hash value. If so, the group membership field 540 of the matching entry 510 is updated to include the group. Otherwise, an entry 510 is created in database 500, the hash value field 520 of the created entry 510 is updated to include the generated hash value and the group membership field 540 is updated to include the group. The sequence ends at step 695.

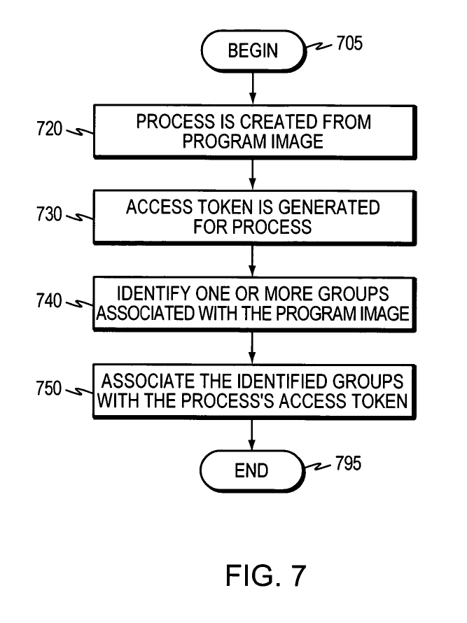

In accordance with an aspect of the present invention, when a process is created an access token is associated with the process and the group associated with the program image is assigned to the process's copy of the access token. FIG. 7 is a flow chart of a sequence of steps that may be used to assign a group to a process's access token in accordance with an aspect of the present invention.

The sequence begins at step 705 and proceeds to step 720 where a process is created from a program image. At step 730, an access token 400 is generated for the process. Illustratively, if the process was created by a user executing the program image, the access token 400 is generated from a copy of the user's access token. Likewise, illustratively if the process was created from another process, the access token 400 is generated from a copy of the parent process's access token 400.

At step 740, one or more groups associated with the program image are identified. Illustratively, the access control driver 134 generates a hash value for the program image. The access control driver 134 then scans the database 500 for an entry 510 that contains a hash value 520 that matches the hash value generated for the program image. The groups associated with the program image are illustratively identified from the group membership field 540 of the matching entry 510. Illustratively, if a matching entry 510 is not found in the database 500, no groups are identified for the program image. Alternatively, if no matching entry 510 is found, a default set of groups may be illustratively identified for the program image.

At step 750, the one or more identified groups are associated with the process's access token 400. Illustratively, access control driver 134 associates the one or more identified groups with the access token 400 by copying the identified groups to the access token's security principal list field 430. The sequence then ends at step 795.

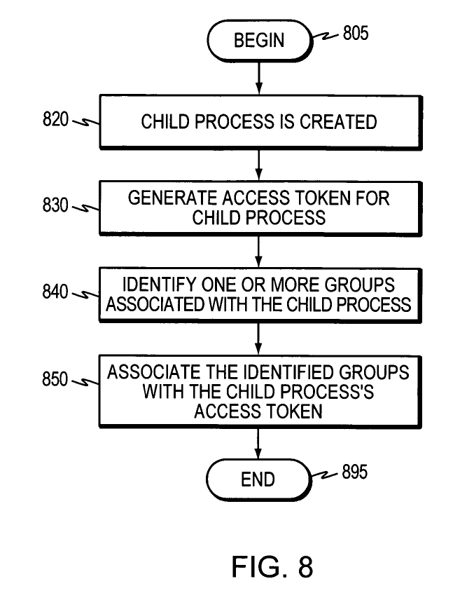

In accordance with an aspect of the present invention, groups may be assigned to access tokens associated with child processes that are illustratively “spawned” by a parent process. FIG. 8 is a flow chart of a sequence of steps that may be used to assign a group to an access token associated with a child process in accordance with an aspect of the present invention.

The sequence begins at step 805 and proceeds to step 820 where a child process is created from the parent process by e.g., the operating system 132. Illustratively, the parent process “spawns” the child process by calling software functions contained in the operating system 132 which create the child process from a program image. At step 830, an access token 400 is generated for the child process. Illustratively, the access token 400 is generated by making a copy of the parent process's access token and attaching the copy to the child process. Next, at step 840, one or more groups are identified for the child process as described above. At step 850, the identified groups are associated with the child process's access token 400. Illustratively, access control driver 134 associates the child process's access token 400 with the identified groups by copying the identified groups to the access token's security principal list field 420. The sequence ends at step 895.

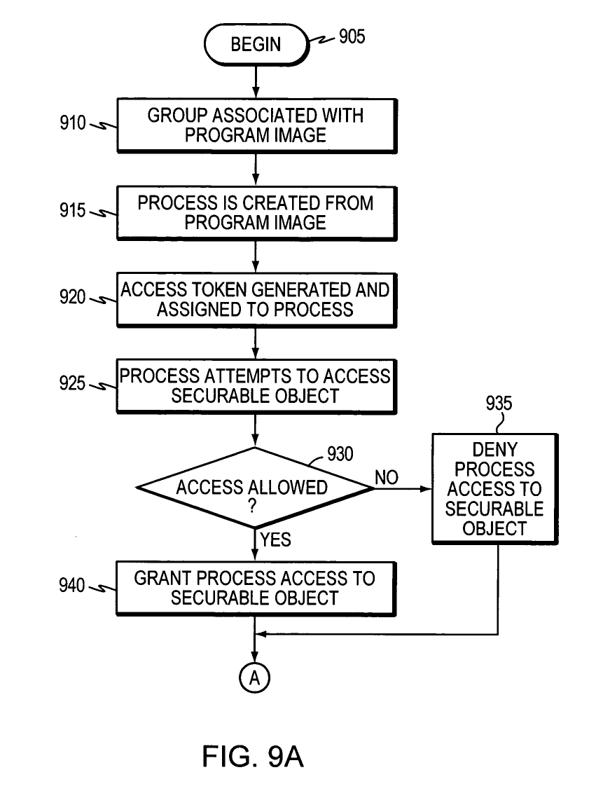

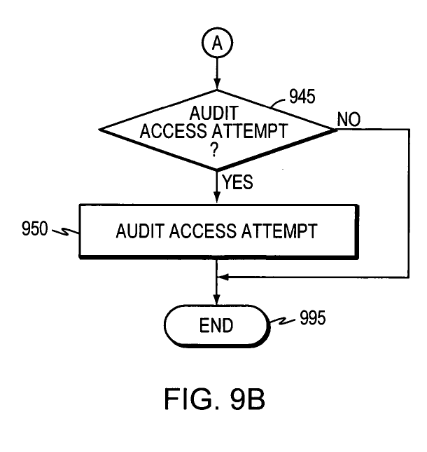

As noted above, (i) groups are associated with program images, (ii) a process is created from a program image and (iii) an access token which contains the group is generated for the process. The process's access token is used to determine if the process has permission to access a particular securable object and if the process's attempt to access the securable object is audited. FIGS. 9A-B are a flow chart of a sequence of steps that may be used to create a process, generate an access token for the process, utilize the process's access token to access a securable object and audit the process's access to the securable object in accordance with an aspect of the present invention.

The sequence begins at step 905 and proceeds to step 910 where a group is associated with a program image, illustratively as described above. At step 915, the program image is executed which creates a process. An access token for the process is generated as described above (step 920). At step 925, the process attempts to access a securable object in the system.

At step 930, a check is performed to determine if the process has permission to access the securable object. Illustratively, the NSS 138 examines the process's access token 400 and the securable object's security descriptor 200 to determine if the process should be granted access to the securable object. Specifically, the discretionary ACEs in the securable object's DACL 230 are scanned to determine if they indicate that a security principal listed in the process's access token 400 has permission to access the securable object; and if so, the sequence proceeds to step 940 where the process is allowed to access the securable object. Otherwise, the sequence proceeds to step 935 where the process is denied access to the securable object.

At step 945 (FIG. 9B), a check is performed to determine if the attempt to access the securable object is audited. Specifically, the NSS 138 scans the system ACEs in the securable object's SACL 240 to determine if they indicate a security principal listed in the process's access token 400 should trigger an audit to the process's attempted access to the securable object. If not, the sequence proceeds to step 995. Otherwise, the sequence proceeds to step 950 where the attempted access is audited. The sequence ends at step 995.

For example, assume that a program image is to be associated with a particular group and a user at computer system 100 wishes to execute the program image to access various securable objects on system 100. In accordance with an aspect of the present invention, a group is associated with the program image, illustratively as described above (step 910). A process 139 is created from the program image by illustratively executing the program image (step 915). An access token is generated and assigned to the process 139, illustratively as described above (step 920).

The process 139 attempts to access a securable object on system 100 (step 925). Illustratively, the process 139 executes a function that requests access to a particular securable object from the operating system 132. The operating system 132 hands the request to the NSS 138 which processes it including determining if the process 139 is granted or denied access to the securable object. Specifically, the NSS 138 illustratively examines the process's access token 400 and the securable object's security descriptor 200 to determine if access to the securable object should be granted or denied, as described above (step 930). If access is granted (allowed), the operating system 132 allows the process 139 to access the securable object (step 940). If access is denied, the operating system 132 denies the process 139 access to the securable object (step 935).

A check is performed to determine if the process's attempted access to the securable object is audited (step 945). Specifically, the NSS 138 illustratively scans the securable object's system ACEs to determine if they indicate the process's attempted access to the securable object is audited. If so, the attempted access is audited (step 950).

It should be noted that in the above described embodiment of the present invention, certain functions associated with controlling processes' access to securable objects including generating access tokens for processes as well as assigning identified groups to the access tokens is performed by a driver contained in the operating system. However, this is not intended to be a limitation of the present invention. Rather, in other embodiments, these functions are incorporated in other areas of the operating system which may include incorporating some combination of these functions into the operating system's NSS.

While this invention has been particularly shown and described with references to preferred embodiments thereof, it will be understood by those skilled in the art that various changes in form and details may be made therein without departing from the scope of the invention encompassed by the appended claims.

What is claimed is:

1. An apparatus for providing access control to securable objects in a computer system, the apparatus comprising:
a memory containing an operating system; and
a processor coupled to the memory, the processor configured to:
(a) generate an access token for a process,
(b) identify one or more groups associated with a program image from which the process was created, and
(c) associate the identified one or more groups with the access token.

2. An apparatus as defined in claim 1 wherein the process is a child process.

3. An apparatus as defined in claim 1 wherein the processor is further configured to:
(a) create a group,
(b) define rights for the group, and
(c) associate the program image with the created group.

4. An apparatus as defined in claim 1 further comprising:
a software driver embodied to perform step c.

5. An apparatus as defined in claim 1 wherein each securable object is associated with a security descriptor structure having an access control list (ACL) that contains access control entries (ACEs) wherein the ACEs define permissions that one or more security principals have to access the securable object.

6. An apparatus as defined in claim 5 wherein the processor is further configured to:
(a) determine if the ACL indicates that a security principal associated with the process has permission to access the securable object, and
(b) if so, allow the process access to the securable object.

7. An apparatus as defined in claim 5 wherein the processor is further configured to:
(a) determine if the ACL indicates that a security principal associated with the process has permission to access the securable object, and
(b) if not, deny the process access to the securable object.

8. In a computer system having one or more securable objects, a method for providing access control to the securable objects comprising the steps of:
generating an access token for a process;
identifying one or more groups associated with a program image from which the process was created; and
associating the identified one or more groups with the access token.

9. A method as defined in claim 8 wherein the process is a child process.

10. A method as defined in claim 8 further comprising the steps of:
creating a group;
defining rights for the group; and
associating the program image with the created group.

11. A method as defined in claim 8 wherein each securable object is associated with a security descriptor structure having an access control list (ACL) that contains access control entries (ACEs) wherein the ACEs define permissions that one or more security principals have to access the securable object.

12. A method as defined in claim 11 further comprising the steps of:
determining if the ACL indicates that a security principal associated with the process has permission to access the securable object; and
if so, allowing the process access to the securable object.

13. A method as defined in claim 11 further comprising the steps of:
determining if the ACL indicates that a security principal associated with the process has permission to access the securable object; and
if not, denying the process access to the securable object.

14. A computer-readable medium comprising computer-executable instructions for execution in a processor for:
generating an access token for a process;
identifying one or more groups associated with a program image from which the process was created; and
associating the identified one or more groups with the access token.

15. A computer-readable medium as defined in claim 14 wherein the process is a child process.

16. A computer-readable medium as defined in claim 14 wherein each securable object is associated with a security descriptor entry having an access control list (ACL) that contains access control entries (ACEs) wherein the ACEs define permissions that one or more security principals have to access the securable object.

17. A computer-readable medium as defined in claim 16 further comprising computer-executable instructions for execution in a processor for:
determining if the ACL indicates that a security principal associated with the process has permission to access the securable object; and
if so, allowing the process access to the securable object.

18. A computer-readable medium as defined in claim 16 further comprising
computer-executable instructions for execution in a processor for:
determining if the ACL indicates that a security principal associated with the process has permission to access the securable object; and
if not, denying the process access to the securable object.

19. Electromagnetic signals traveling on a data network, the electromagnetic signals carrying instructions for execution on a processor for practicing a method of:
generating an access token for a process;
identifying one or more groups associated with a program image from which the process was created; and
associating the identified one or more groups with the access token.

20. Electromagnetic signals as defined in claim 19 wherein the process is a child process.
